(19) United States
(12) Patent Application Publication
(10) Pub. No.: US 2017/0185471 A1
(43) Pub. Date: Jun. 29, 2017

(54) Method and Electronic Device for Controlling Reporting of Crash Data

(71) Applicants: Le Holdings (Beijing) Co., Ltd., Beijing (CN); Le Shi Zhi Xin Electronic Technology (Tianjin) Limited, Tianjin (CN)

(72) Inventors: Fanxin Zeng, Tianjin (CN); Xiaozong Chai, Tianjin (CN); Xinjing Yang, Tianjin (CN); Yuhang Duan, Tianjin (CN)

(21) Appl. No.: 15/243,112

(22) Filed: Aug. 22, 2016

Related U.S. Application Data
(63) Continuation of application No. PCT/CN2016/088445, filed on Jul. 4, 2016.

(30) Foreign Application Priority Data
Dec. 25, 2015 (CN) 2015110047348

(51) Int. Cl. G06F 11/07

(52) U.S. Cl. CPC G06F 11/0781; G06F 11/0742; G06F 11/0751; G06F 11/0775; G06F 11/079; G06F 11/0778

(57) ABSTRACT

Disclosed are a method and electronic device for controlling reporting of crash data, wherein the method includes: configuring a data filtering list according to control parameters; sending the data filtering list to the client, and instructing the client to filter crash data according to the data filtering list; and receiving the crash data filtered according to the data filtering list and reported by the client. According to the method, the server configures the data filtering list, and then the client can determine requirements for reporting the current crash data according to the data filtering list, so that the crash data more in line with the needs of the server are reported, and the method can be applicable to the case of system version update.

### CROSS REFERENCE TO RELATED APPLICATIONS

This application is a continuation of International Application No. PCT/CN2016/088445, filed Jul. 4, 2016, and claims priority to Chinese Patent Application No. 201511004734.8, filed Dec. 25, 2015, the disclosures of which are hereby incorporated in their entirety by reference.

### TECHNICAL FIELD

The disclosure relates to the field of data upload technology in the communication field, and particularly relates to a method and electronic device for controlling reporting of crash data.

### BACKGROUND

The crash of a mobile phone refers to a phenomenon that exceptions happen in an operating system on the mobile phone and an APP on the mobile phone during operation and cause the APP or the system to be temporarily unavailable or auto reboot.

In order to enhance the user experience and modify the defects of the original version, mobile phone manufacturers will regularly release new mobile phone operating system versions, and the actual operation of a new system after release is collected and counted by reporting crash data to a server terminal. With the increase of the version and continuous increase of the crash data volume, massive useless or needless crash data abound in a crash database on the server terminal, and bring an adverse effect on crash data statistics of the server terminal, therefore, how to control the reporting of the crash data has become a common problem faced by many mobile phone manufacturers.

At present, the common practice within industry is that a crash data reporting blacklist is built in a mobile phone operating system, and the crash data in the blacklist cannot be reported. Because the crash data reporting requirements will be slightly different as the version differs, and the crash data reporting requirements of the same version will also change as time goes on, the practice of building the crash data reporting blacklist in the mobile phone operating system cannot adapt to the two situations.

### SUMMARY

In order to overcome the defect that the existing method for controlling reporting of crash data cannot adapt to system version update, according to one aspect of the disclosure, a method for controlling reporting of crash data is provided.

In the first place, a method for controlling reporting of crash data, provided by the embodiments of the disclosure, comprises: configuring a data filtering list according to control parameters, the control parameters comprising one or more of system version information, an application name and an error type, and the data filtering list being a data filtering blacklist or a data filtering white list; sending the data filtering list to the client, and instructing the client to filter crash data according to the data filtering list; and receiving the crash data filtered according to the data filtering list and reported by the client.

In the second place, the embodiment of the disclosure further provides a non-transitory computer-readable storage medium storing executable instructions that, when executed by an electronic device, cause the electronic device to executing any of the above method for controlling reporting of crash data.

In the third place the embodiment of the disclosure further provides an electronic device, comprising: at least one processor; and a memory communicably connected with the at least one processor for storing instructions executable by the at least one processor, wherein execution of the instructions by the at least one processor causes the at least one processor to executing any of the above method for controlling reporting of crash data.

Among the method, the server and the client for controlling reporting of crash data, provided by the embodiments of the disclosure, the method may be applied to the server side or the client side. The data filtering list is configured by the server, namely the control right of the reporting of the crash data is transferred to the server terminal; and the client can determine the requirements for reporting the current crash data according to the data filtering list, so that the crash data more in line with the needs of the server are reported, and the method can be applicable to the case of system version update. Meanwhile, the data filtering list is configured on the server terminal according to the control parameters that may include multiple parameters, the data filtering list can be used for filtering the crash data which match multiple ones of the control parameters at the same time, or the data filtering list is used for filtering the crash data that match each one of the control parameters, respectively, so that the data filtering list can be reasonably configured according to actual needs, and a variety of filtering needs can be met.

Other features and advantages of the disclosure will be stated in the subsequent description, and partially become apparent from the description, or will be understood by implementation of the disclosure. The object and other advantages of the disclosure can be achieved and obtained through the structures particularly specified in the written description, claims, and drawings.

Hereinafter, the technical solution of the disclosure is further described in details through the accompanying drawings and embodiments.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram of a method for controlling reporting of crash data on a server side in the embodiment of the disclosure;

FIG. 2 is a flow diagram of a method for controlling the reporting of the crash data on a client side in the embodiment of the disclosure;

FIG. 3 is a flow diagram of a method for controlling the reporting of the crash data in embodiment 1 of the disclosure;

FIG. 4 is a first structure diagram of a server for controlling the reporting of the crash data in the embodiment of the disclosure;

FIG. 5 is a second structure diagram of the server for controlling the reporting of the crash data in the embodiment of the disclosure;

FIG. 6 is a first structure diagram of a client for controlling the reporting of the crash data in the embodiment of the disclosure;

FIG. 7 is a second structure diagram of the client for controlling the reporting of the crash data in the embodiment of the disclosure; and

FIG. 8 is a structure block diagram of the electronic device for controlling the reporting of the crash data in the embodiment of the disclosure.

### DETAILED DESCRIPTION

In order to make the object, the technical solution and the advantages of the embodiments of the disclosure clearer, hereinafter, the technical solution in the embodiments of the present application is clearly and completely described with reference to the drawings in the embodiments of the disclosure. Obviously, the described embodiments are a part, not all of the embodiments of the present application. On the basis of the embodiments of the present application, all other embodiments obtained by those of ordinary skill in the art without making creative works are within the protection scope of the present application.

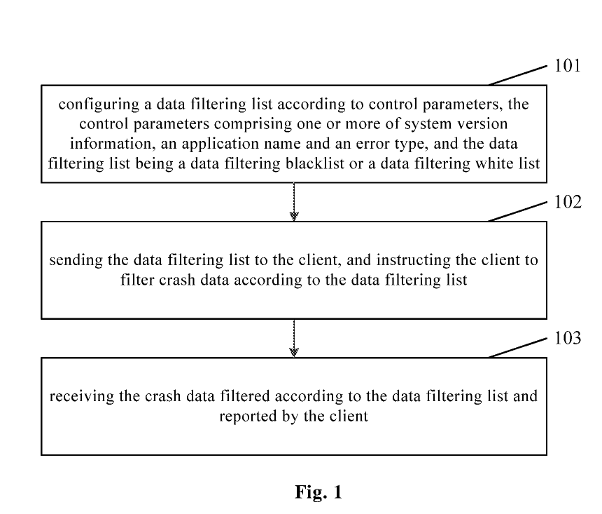

According to the embodiments of the disclosure, a method for controlling reporting of crash data is provided and is applied to a server terminal. As shown in FIG. 1, the method comprises steps 101-103:

S101 includes configuring a data filtering list according to control parameters, the control parameters comprising one or more of system version information, an application name and an error type, and the data filtering list being a data filtering blacklist or a data filtering white list.

In the embodiment of the disclosure, the control parameters are used for configuring a data filtering list, and specifically may comprise multiple parameters, for example, the control parameters comprise one or more of system version information, an application name and an error type, wherein the system version information specifically refers to a system version number, for example, V2.0 or V3.1.1, etc.; the application name specifically refers to the name of a certain application; and the error type specifically refers to one of preset types, or a certain error code.

Meanwhile, the data filtering list is used for filtering the crash data. Specifically, the data filtering list is a data filtering blacklist or a data filtering white list. After the server sends the data filtering list to the client, when the data filtering list is a data filtering blacklist, the client filters out the data matching the data filtering blacklist in the crash data, and transmits the remaining unfiltered data to the server. When the data filtering list is a data filtering white list, the client retains the data matching the data filtering white list in the crash data, namely the client filters out other unmatched data and transmits the crash data matching the data filtering white list to the server.

S102 includes sending the data filtering list to the client, and instructing the client to filter crash data according to the data filtering list.

S103 includes receiving the crash data filtered according to the data filtering list and reported by the client.

In the embodiment of the disclosure, the data filtering list is configured by the server, and the client can determine the requirements for reporting the current crash data according to the data filtering list, so that the crash data more in line with the needs of the server are reported. The attributes of three dimensions, i.e., the system version information, the application name and the error type can be configured on the server terminal, the separate control on the reporting of the crash data can be performed with respect to a system version number, an application name or an error type, respectively, or comprehensive control can be performed by combining the three parts together.

Specifically, taking the case that the data filtering list is a data filtering blacklist as an example: when the data filtering blacklist is configured according to the system version information, all the crash data matching the system version information are not reported, for example, the system version information is a version number Android V2.0, the system version number of a certain mobile phone is also Android V2.0, and then all the crash data of the mobile phone are not reported. When the data filtering blacklist is configured according to the application name, all the crash data matching the application name are not reported, for example, if the application name is “A Sports News”, then the crash data of an application of “A Sports News” in the client do not need to be reported. In the same way, when the data filtering blacklist is configured according to the error type, all the crash data matching the error type are not reported.

Optionally, in the embodiments of the disclosure, when the control parameters comprise multiple parameters (namely when the data filtering list is configured according to multiple ones of the control parameters), the data filtering list is used for filtering the crash data which match multiple ones of the control parameters at the same time; or the data filtering list is used for filtering the crash data which meet every control parameter, respectively.

Specifically, the data filtering list can be used for filtering the crash data which match multiple ones of the control parameters at the same time. Taking the case that the data filtering list is a data filtering blacklist as an example: when the data filtering blacklist is configured according to the system version information and the application name, the crash data matching the system version information and the application name at the same time are filtered, for example, if the system version information is a version number Android V2.0, and the application name is “A Sports News”, then all the crash data generated by the “A Sports News” under this system version number need to be filtered, that is to say, the crash data generated by other applications under this system version number also need to be reported to the server (namely the crash data of the intersection set in line with the system version information and in line with the application are used as the final crash data needing to be filtered).

Or, the data filtering list is used for filtering the crash data which match each one of the control parameters, respectively. Also taking the case that the data filtering list is a data filtering blacklist as an example: when the data filtering blacklist is configured according to the system version information and the application name, the crash data matching the system version information are filtered, and the crash data matching the application name also need to be filtered at the same time (the same as the principle that two data filtering blacklists are generated according to the system version information and the application name respectively, and the crash data are filtered according to the two data filtering blacklists respectively). Specifically, for example, if the system version information is a version number Android V2.0, and the application name is “A Sports News”, all clients with system version numbers of Android V2.0 do not need to report the crash data, and the crash data generated by “A Sports News” applications in other system version numbers also need to be filtered (that is to say, the crash data of the union set in line with the system version information and in line with the application are used as the final crash data needing to be filtered).

Optionally, the method also comprises: configuring one or more data filtering lists according to different control parameters, generating a data filtering list listing including one or more data filtering lists, and sending the data filtering list listing to a client.

In the embodiment of the disclosure, as the crash data of multiple system version numbers or the crash data of multiple applications or the like need to be filtered, a data filtering list listing is set. Specifically, data filtering list listing includes one or more above-mentioned data filtering lists. For example, a first data filtering blacklist is configured according to the system version information of Android V2.0, a second data filtering blacklist is configured according to the system version information of Android V3.0 at the same time, and the two data filtering blacklists are both added into the data filtering list listing. Therefore, when the client receives the data filtering list listing, if the system version number of the client is Android V2.0 or Android V3.0, all the crash data are filtered, namely the crash data are not reported.

According to the method for controlling the reporting of the crash data, provided by the embodiment of the disclosure, the data filtering list is configured by the server, namely the control right of the reporting of the crash data is transferred to the server terminal; and the client can determine the requirements for reporting the current crash data according to the data filtering list, so that the crash data more in line with the needs of the server can be reported. Meanwhile, the data filtering list is configured on the server terminal according to the control parameters that may include multiple parameters, the data filtering list can be used for filtering the crash data which match multiple ones of the control parameters at the same time, or the data filtering list is used for filtering the crash data that match each one of the control parameters, respectively, so that the data filtering list can be reasonably configured according to actual needs, and a variety of filtering needs can be met.

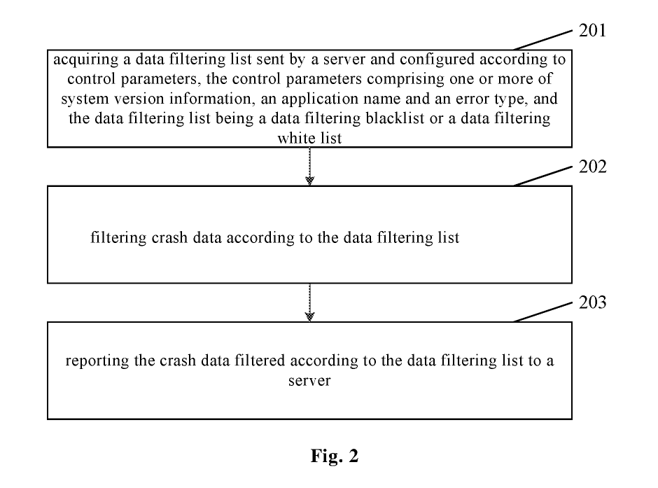

Based on the same inventive concept, the embodiment of the disclosure also provides a method for controlling reporting of crash data and applied to a client side. As shown in FIG. 2, the method comprises steps 201-203:

S201 includes acquiring a data filtering list sent by a server and configured according to control parameters, the control parameters comprising one or more of system version information, an application name and an error type, and the data filtering list being a data filtering blacklist or a data filtering white list.

S202 includes filtering crash data according to the data filtering list.

S203 includes reporting the crash data filtered according to the data filtering list to a server.

The client can generate various crash data in operation, and in the embodiment of the disclosure, as the data filtering list is configured by the server, the client can determine the requirements for reporting the current crash data according to the data filtering list, so that the crash data more in line with the needs of the server are reported.

Optionally, the method also comprises:

receiving the data filtering list listing sent by the server, the data filtering list listing including one or more data filtering lists configured according to different control parameters.

Optionally, when the control parameters comprise multiple parameters, filtering the crash data according to the data filtering list in S202 specifically comprises:

filtering the crash data which match multiple ones of the control parameters at the same time according to the data filtering list; or

filtering the crash data which match each one of the control parameters, respectively, according to the data filtering list.

Hereinafter, the flow of the method for controlling reporting of crash data is described in details through one embodiment.

### Embodiment 1

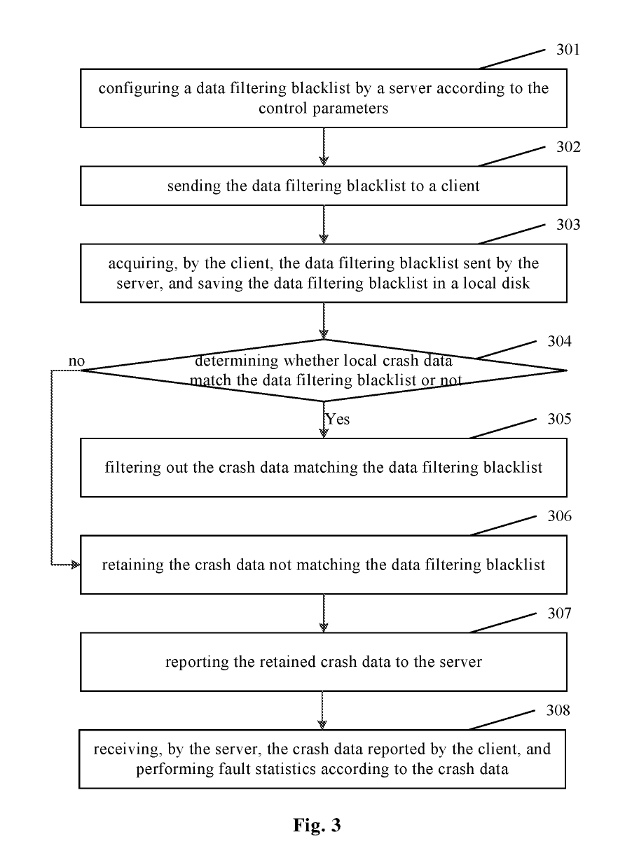

In embodiment 1, control parameters comprise two parameters: system version information and application name; and the data filtering list is used for filtering the crash data which match the two of the control parameters at the same time. As shown in FIG. 3, the method specifically comprises steps 301-308:

S301 includes configuring a data filtering blacklist by a server according to the control parameters.

Wherein, the control parameters comprise system version information and an application name, i.e., the server configures the data filtering blacklist according to the system version information and the application name.

S302 includes sending the data filtering blacklist to a client.

S303 includes acquiring, by the client, the data filtering blacklist sent by the server, and saving the data filtering blacklist in a local disk.

S304 includes determining whether local crash data match the data filtering blacklist or not, if so, continuing to perform S305, otherwise, continuing to perform S306.

Wherein, in S304, the data filtering blacklist is used for filtering the crash data which match multiple ones of the control parameters at the same time, namely filtering out the crash data which match both the system version information and the application name. Only when the crash data match both the system version information and the application name, the crash data match the data filtering blacklist.

S305 includes filtering out the crash data matching the data filtering blacklist.

In embodiment 1, filtering out the crash data does not mean deleting the crash data, the crash data are still stored in a disk of the client, but in this process, the crash data just do not need to be reported.

S306 includes retaining the crash data not matching the data filtering blacklist.

S307 includes reporting the retained crash data to the server.

S308 includes receiving, by the server, the crash data reported by the client, and performing fault statistics according to the crash data.

The method for controlling the reporting of the crash data, provided by the embodiments of the disclosure, is applied to the server terminal or the client side. The data filtering list is configured by the server, namely the control right of the reporting of the crash data is transferred to the server terminal; and the client can determine the requirements for reporting the current crash data according to the data filtering list, so that the crash data more in line with the needs of the server can be reported. Meanwhile, the data filtering list is configured on the server terminal according to the control parameters that may include multiple parameters, the data filtering list can be used for filtering the crash data which match multiple ones of the control parameters at the same time, or the data filtering list is used for filtering the crash data that match each one of the control parameters, respectively, so that the data filtering list can be reasonably configured according to actual needs, and a variety of filtering needs can be met.

The flow of the method for controlling reporting of crash data is described in details above, the method may also be implemented through a corresponding device, and hereinafter, the structure and functions of the device are described in details.

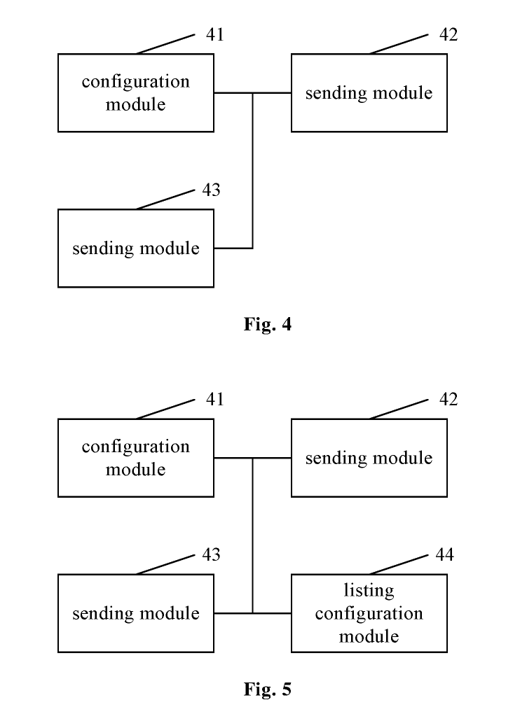

The server for controlling reporting of crash data, provided by the embodiment of the disclosure, as shown in FIG. 4, comprises: a configuration module 41, a sending module 42 and a receiving module 43.

The configuration module 41 is used for configuring a data filtering list according to control parameters, the control parameters comprising one or more of system version information, an application name and an error type, and the data filtering list being a data filtering blacklist or a data filtering white list;

The sending module 42 is used for sending the data filtering list to the client, and instructing the client to filter crash data according to the data filtering list; and

The receiving module 43 is used for receiving the crash data filtered according to the data filtering list and reported by the client.

Optionally, as shown in FIG. 5, the server also comprises: a listing configuration module 44, used for configuring one or more data filtering lists according to different control parameters, generating a data filtering list listing including one or more data filtering lists, and sending the data filtering list listing to a client.

Optionally, when the control parameters comprise multiple parameters, the data filtering list is used for filtering the crash data which match multiple ones of the control parameters at the same time; or

the data filtering list is used for filtering the crash data which match each one of the control parameters, respectively.

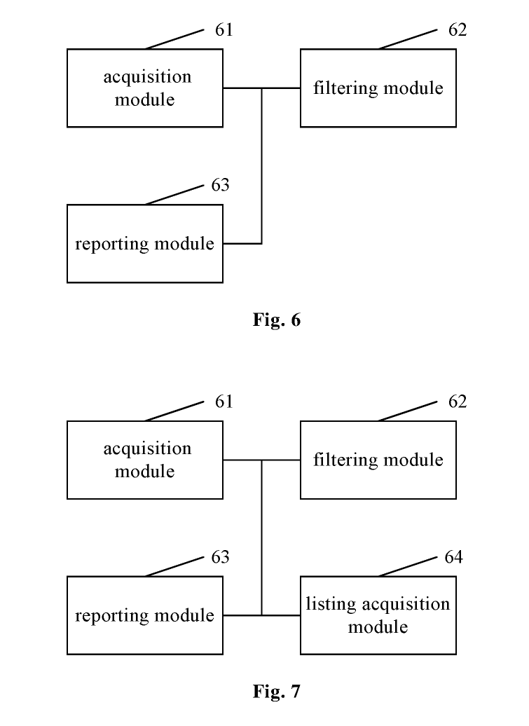

Based on the same inventive concept, the embodiment of the disclosure also provide a client for controlling reporting of crash data, as shown in FIG. 6, comprising: an acquisition module 61, a filtering module 62 and a reporting module 63.

The acquisition module 61 is used for acquiring a data filtering list sent by a server and configured according to control parameters, the control parameters comprising one or more of system version information, an application name and an error type, and the data filtering list being a data filtering blacklist or a data filtering white list;

The filtering module 62 is used for filtering crash data according to the data filtering list; and

The reporting module 63 is used for reporting the crash data filtered according to the data filtering list to a server.

Optionally, as shown in FIG. 7, the client also comprises: a listing acquisition module 64, used for receiving the data filtering list listing sent by the server, the data filtering list listing including one or more data filtering lists configured according to different control parameters.

Optionally, when the control parameters comprise multiple parameters, the filtering module 62 is specifically used for:

filtering the crash data which match multiple ones of the control parameters at the same time according to the data filtering list; or

filtering the crash data which match each one of the control parameters, respectively, according to the data filtering list.

Among the method, the server and the client for controlling reporting of crash data, provided by the embodiments of the disclosure, the method may be applied to the server terminal or the client side. The data filtering list is configured by the server, namely the control right of the reporting of the crash data is transferred to the server terminal; and the client can determine the requirements for reporting the current crash data according to the data filtering list, so that the crash data more in line with the needs of the server are reported, and the method can be applicable to the case of system version update. Meanwhile, the data filtering list is configured on the server terminal according to the control parameters that may include multiple parameters, the data filtering list can be used for filtering the crash data which match multiple ones of the control parameters at the same time, or the data filtering list is used for filtering the crash data that match each one of the control parameters, respectively, so that the data filtering list can be reasonably configured according to actual needs, and a variety of filtering needs can be met.

According to the embodiment of the disclosure, a non-transitory computer-readable storage medium is provided, and the non-transitory computer-readable storage medium stores executable instructions that, when executed by an electronic device, cause the electronic device to executing the method for controlling reporting of crash data provided by the above embodiments of the disclosure.

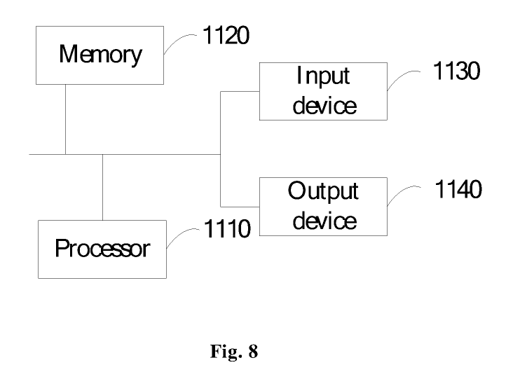

FIG. 8 is a schematic diagram of the hardware structure of electronic device executing the method for controlling reporting of crash data, provided by an embodiment of the disclosure. As shown in FIG. 8, the device comprises one or more processors 1110 and a memory 1120. A case of one processor 1110 is taken as an example in FIG. 8.

The device executing the method for controlling reporting of crash data further comprises an input device 1130 and an output device 1140.

The processor 1110, the memory 1120, the input device 1130 and the output device 1140 may be connected through a bus or in other ways. A case of bus connection is taken as an example in FIG. 8.

As a non-transitory computer-readable storage medium, the memory 1120 can be used for storing non-transitory software programs, non-transitory computer executable programs and modules, such as program instructions/modules ( i.e., the configuration module 41, the sending module 42 and the receiving module 43 as shown in FIG. 4) corresponding to the method for controlling reporting of crash data described in the embodiment of the disclosure.

The memory 1120 further comprises a program storage area and a data storage area, wherein the program storage area can store an operating system or application programs required by at least one function, and the data storage area can store data, etc., created according to using of the device for controlling reporting of crash data. In addition, the memory 1120 may include a high speed random access memory and further may include a non-transitory memory, such as at least one disk memory, a flash memory, or other non-transitory solid-state memories. In some embodiments, the storage 1120 optionally include memories set up remotely relative to the processor 1110, and these remote memories can be connected to the device for controlling reporting of crash data through a network. The above-mentioned networks include but are not limited to the Internet, Intranet, LAN, mobile communication networks and a combination thereof.

The input device 1130 can receive input figure or character information and generate key signal inputs in connection with user settings and function control of the device for controlling reporting of crash data. The output device 1140 may include display devices such as a display screen.

The one or more modules are stored in the memory 1120 and are used for executing the method for controlling reporting of crash data disclosed in any of the above-mentioned method embodiments when executed by one or more processors 1110.

The above-mentioned product can execute the method provided by the embodiments of the disclosure and has corresponding functional modules executing the method and beneficial effects. The technical details not described in the embodiment in detail are available with reference to the method provided by the embodiments of the disclosure.

The electronic device in the embodiments of the disclosure exists in many forms, including but not limited to:

Mobile communication equipment: this type of device is featured with a mobile communication function, and is mainly used for providing voice and data communication. These terminals include: a smartphone (e.g. iPhone), a multimedia phone, a functionality phone, and a low-end phone, and the like.

Ultra mobile personal computer equipment: this type of equipment belongs to the range of personal computers, and is provided with computation and processing functions, and typically has a mobile internet characteristic. These terminals include: PDA, MID and UMPC equipment, and the like, such as iPad.

Portable recreation equipment: this type of equipment can display and play multimedia contents. This type of equipment include: voice and audio players (such as iPod), handheld game players, e-books, intelligent toys and portable vehicle navigation equipment.

Servers: apparatus can provide computing service, and servers include: processors, hard disks, memories, system buses and the like, architecture of the servers is similar to that of a general-purpose computer, however, due to requirement for providing high-quality and reliable service, the requirements on processing capability, stability, reliability, safety, expandability, manageability and other aspects are higher.

Other electronic devices with a data interaction function.

The device embodiments described above are merely exemplary, wherein units described as separated components can be or cannot be separated physically, components displayed as units can be or cannot be physical units, namely can be located in one place, or can be distributed on multiple network units. The object of the solution of the embodiments can be achieved by selecting part or all of modules according to practical demands.

Based on the above description of the embodiments, it can be clearly appreciated by person skilled in the art that the embodiments can be implemented in a way of combination of software and a universal hardware platform or through hardware certainly. Based on such understanding, the nature of the above-mentioned technical solution or its part making contribution to relevant technology can be embodied in form of software. The computer software product can be stored in a computer-readable storage medium, such as ROM/RAM, a disk, CD, etc. and comprises a plurality of instructions for enabling one set of computer equipment ( which may be a personal computer, a server or network equipment, etc.) to execute the method described in all embodiments or in part of an embodiment.

Finally, it should be noted that the above-mentioned embodiments are only used for explaining the technical solution of this application but not for limiting it. Even though this application has been described in detail with reference to the aforesaid embodiments, it should be understood that person skilled in the art still can modify the technical solutions disclosed in the above-mentioned embodiments or make equivalent substitutions to part of technical features; and these modifications or substitutions will not depart the corresponding technical solutions essentially from the spirit and scope of the technical solutions of all embodiments of this application.

What is claimed is:

1. A method for controlling reporting of crash data, executed by a server, comprising:
configuring a data filtering list according to control parameters, the control parameters comprising one or more of system version information, an application name and an error type, and the data filtering list being a data filtering blacklist or a data filtering white list;
sending the data filtering list to the client, and instructing the client to filter crash data according to the data filtering list; and
receiving the crash data filtered according to the data filtering list and reported by the client.

2. The method according to claim 1, further comprising:
configuring one or more data filtering lists according to different control parameters, generating a data filtering list listing including one or more data filtering lists, and sending the data filtering list listing to a client.

3. The method according to claim 1, when the control parameters comprise multiple parameters, the data filtering list is used for filtering the crash data which match multiple ones of the control parameters at the same time; or
the data filtering list is used for filtering the crash data which match each one of the control parameters, respectively.

4. A non-transitory computer-readable storage medium storing executable instructions that, when executed by an electronic device, cause the electronic device to:
configure a data filtering list according to control parameters, the control parameters comprising one or more of system version information, an application name and an error type, and the data filtering list being a data filtering blacklist or a data filtering white list;
send the data filtering list to the client, and instruct the client to filter crash data according to the data filtering list; and
receive the crash data filtered according to the data filtering list and reported by the client.

5. The non-transitory computer-readable storage medium according to claim 4, the instructions are used for causing the electronic device to:
configure one or more data filtering lists according to different control parameters, generate a data filtering list listing including one or more data filtering lists, and send the data filtering list listing to a client.

6. The non-transitory computer-readable storage medium according to claim 4, when the control parameters comprise multiple parameters, the data filtering list is used for filtering the crash data which match multiple ones of the control parameters at the same time; or
the data filtering list is used for filtering the crash data which match each one of the control parameters, respectively.

7. An electronic device, comprising:
at least one processor; and
a memory communicably connected with the at least one processor for storing instructions executable by the at least one processor, wherein execution of the instructions by the at least one processor causes the at least one processor to:
configure a data filtering list according to control parameters, the control parameters comprising one or more of system version information, an application name and an error type, and the data filtering list being a data filtering blacklist or a data filtering white list;
send the data filtering list to the client, and instruct the client to filter crash data according to the data filtering list; and
receive the crash data filtered according to the data filtering list and reported by the client.

8. The electronic device according to claim 7, wherein execution of the instructions by the at least one processor causes the at least one processor to:
configure one or more data filtering lists according to different control parameters, generate a data filtering list listing including one or more data filtering lists, and send the data filtering list listing to a client.

9. The electronic device according to claim 7, when the control parameters comprise multiple parameters, the data filtering list is used for filtering the crash data which match multiple ones of the control parameters at the same time; or
the data filtering list is used for filtering the crash data which match each one of the control parameters, respectively.
